(19) United States
(12) Patent Application Publication
(10) Pub. No.: US 2005/0216274 A1
(43) Pub. Date: Sep. 29, 2005

(54) Object tracking method and apparatus using stereo images

(75) Inventor: Hyunwoo Kim, Incheon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/058,203

(22) Filed: Feb. 16, 2005

(30) Foreign Application Priority Data
Feb. 18, 2004 (KR) 2004-10662

(51) Int. Cl. G10L 19/04

(52) U.S. Cl. 704/276

(57) ABSTRACT

An object tracking method and apparatus, the method includes: segmenting a segment of a zone, in which an object is located, from a current frame among consecutively input images and obtaining predetermined measurement information of the segment; determining a plurality of searching zones centered around the segment and predicting parameters of the segment in the current frame based on measurement information of a preceding frame in the searching zones; selecting predetermined searching zones as partial searching candidate zones from the predicted parameters; measuring a visual cue of the segment; and estimating parameters of the segment of the current frame in the partial searching candidate zones based on the visual cue and the predicted parameters and determining parameters having the largest parameter values from the estimated parameters as parameters of the segment.

### CROSS-REFERENCE TO RELATED APPLICATION

This application claims the benefit of Korean Patent Application No. 10-2004-10662, filed on Feb. 18, 2004 in the Korean Intellectual Property Office, the disclosure of which is incorporated herein by reference.

### BACKGROUND OF THE INVENTION

1. Field of the Invention

The present invention relates to an object tracking method and apparatus, and more particularly, to a method and apparatus tracking a moving object using stereo images.

2. Description of the Related Art

Analyzing human behavior using computer vision has been carried out for decades, and the results of these analyses are applied to video surveillance, content-based image services, virtual reality, customer relationship management, biometrics, and intelligent interfaces. Recently, due to social needs, such as senior or personal security, and new computing environments, such as a smart home or ubiquitous computing, studies analyzing human behavior using computer vision have been further developed.

Visual tracking of a plurality of people is a basic element in human analysis. The visual tracking provides trajectories of the plurality of people or their body parts and becomes a main input element of a human behavior analysis. A method of tracking a person as an object can be approached according to camera configurations. Lately, due to efficiency in combining various observed results on a probabilistic framework, a probabilistic tracking access method is being developed. The probabilistic tracking access method can be divided into a deterministic searching method and a stochastic searching method.

The deterministic searching method has a characteristic of fast object tracking and can be applied when a motion is modeled to a Gaussian function.

The stochastic searching method expands a motion model to a non-Gaussian function when complex background clutters are in an image. The stochastic searching method employs a particle filter. Since the particle filter does not perform a complex analytic calculation and provides a framework suitable for state estimation in a nonlinear or non-Gaussian system on the basis of a Monte-Carlo simulation, it is suitable for tracking a human body.

However, the particle filter requires an impractically large number of particles, i.e., random samples or multiple copies of the variables of interest, for sampling a large dimensional state space. If the number of particles is small, it is difficult to recover from a tracking failure due to a sampling depletion in a state space. Also, the particle filter requires an exact model initialization. However, since the model initialization must be performed manually, it is not practical to employ the particle filter. Also, in the stochastic searching method using the particle filter, if the number of particles and a modeling suited to individual problems are not dealt reasonably, the search may be very slow.

### SUMMARY OF THE INVENTION

According to an aspect of the present invention there is provided a method and apparatus of tracking a plurality of objects by reducing candidate zones, in which an object moves, using a first order deterministic search and estimating a position and scale of the object using a second order stochastic search.

According to an aspect of the present invention, there is provided an object tracking method including: segmenting a segment of a zone, in which an object is located, from a current frame among consecutively input images and obtaining predetermined measurement information of the segment; determining a plurality of searching zones centered around the segment and predicting parameters of the segment in the current frame based on measurement information of a preceding frame in the searching zones; selecting predetermined searching zones as partial searching candidate zones from the predicted parameters; measuring a visual cue of the segment; and estimating parameters of the segment of the current frame in the partial searching candidate zones based on the visual cue and the predicted parameters and determining parameters having the largest values from the estimated parameters as parameters of the segment.

According to another aspect of the present invention, there is provided an object tracking apparatus including: an image inputting unit consecutively inputting images; an image segmenting unit detecting and segmenting a segment of a zone, in which an object is located, from a current frame among the images and obtaining predetermined measurement information of the segment; a predicting unit determining a plurality of searching zones centered around the segment and predicting parameters of the segment in the current frame based on the measurement information of a preceding frame in the searching zone; a visual cue measuring unit measuring a visual cue including at least one of probabilities of average depth information, color information, motion information, and shape information of the segment; and a tracking unit estimating parameters of the segment for the current frame in the partial searching candidate zones based on the visual cue and the predicted parameters and determining the largest parameters among the estimated parameters as parameters of the segment.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of an object tracking apparatus according to an embodiment of the present invention;

FIGS. 2A and 2B are flowcharts of an object tracking method according to an embodiment of the present invention;

FIG. 3A shows cameras installed in a predetermined place for object tracking;

FIG. 3B schematically shows an image output from the camera shown in FIG. 3A;

FIG. 4 schematically shows a zone divided from an image obtained from the cameras shown in FIG. 3A and illustrates a process of obtaining one dimensional depth information along any one directional straight line in a corresponding zone;

FIG. 5 shows a search line and a search ellipse for a deterministic search;

FIGS. 6A through 6D show examples of probabilities obtained from a segment of an object with respect to a plurality of particles;

FIG. 7A shows a depth image having a top-down view;

FIGS. 7B through 7D show results of masking tracked first, second, and third objects, respectively; and

FIG. 8A shows a depth image and FIG. 8B shows a tracked trajectory of an object.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

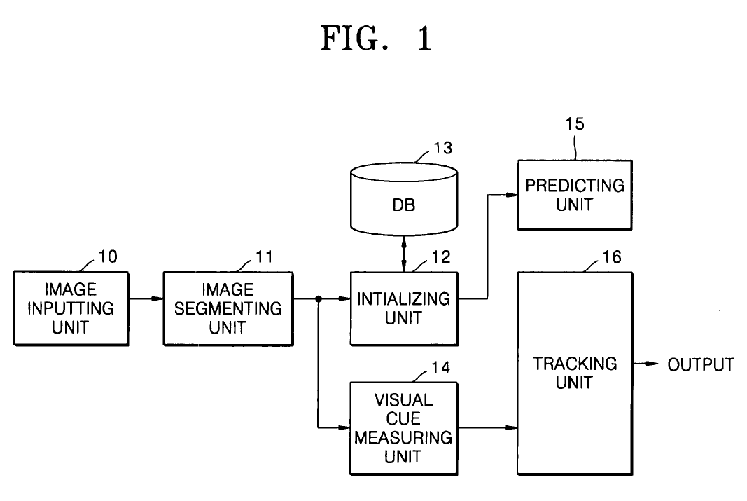

FIG. 1 is a block diagram of an object tracking apparatus according to an embodiment of the present invention. Referring to FIG. 1, the object tracking apparatus includes an image inputting unit 10, an image segmenting unit 11, an initializing unit 12, a database 13, a visual cue measuring unit 14, a predicting unit 15, and a tracking unit 16.

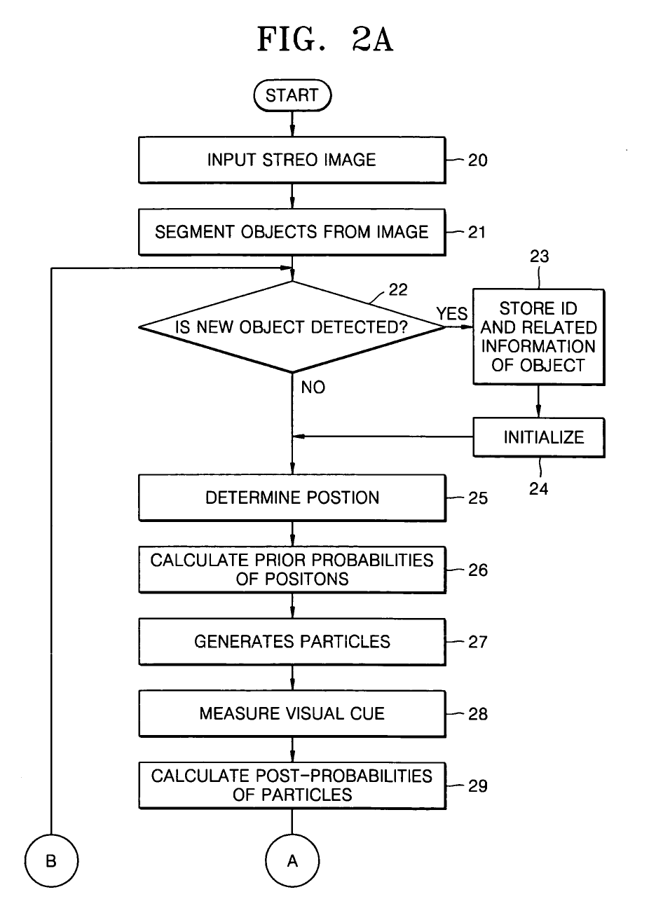

An operation according to the configuration shown in FIG. 1 will now be described with reference to FIGS. 2A and 2B. FIGS. 2A and 2B are flowcharts of an object tracking method according to an embodiment of the present invention.

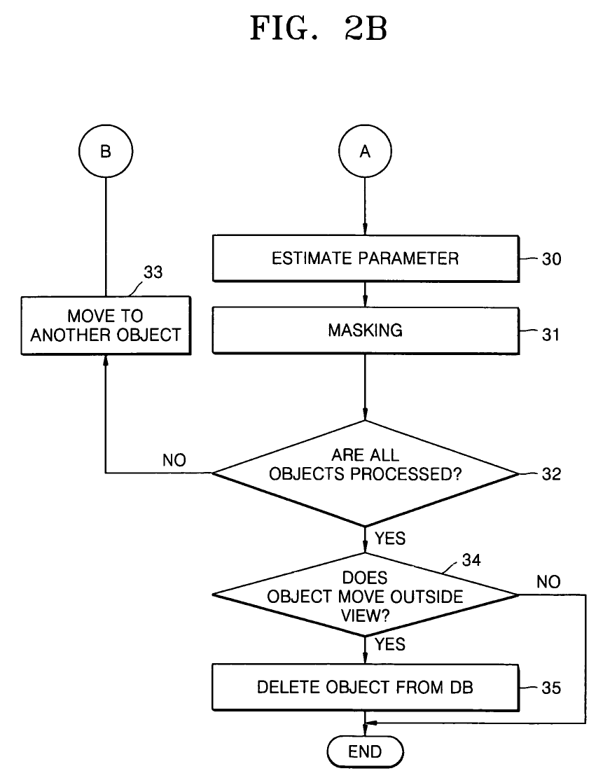

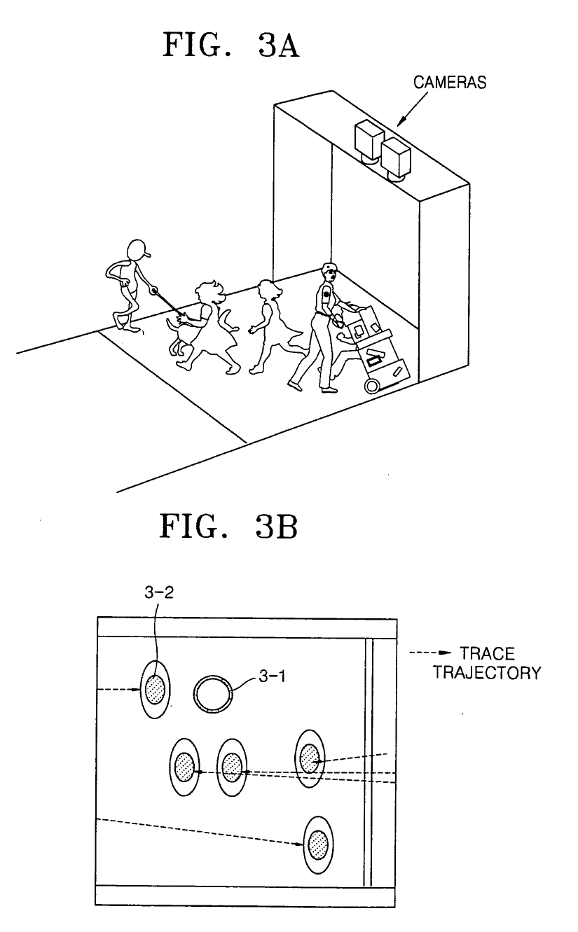

The image inputting unit 10 inputs a stereo image once every predetermined time using two cameras in operation 20. The two cameras are installed on an upper part of a target place as shown in FIG. 3A and have a top-down view. FIG. 3B schematically shows objects through the top-down view, and in a case of a human body, a head and shoulders can be drawn with an ellipse type as shown in a reference number 3-2. A reference number 3-1 indicates a fixed object. While described as two cameras, it is understood that additional cameras can be used, and that the images can be taken from video sources and/or still pictures taken at intervals.

The image segmenting unit 11 detects an object from the input stereo image and segments the detected object from the input stereo image in operation 21. The object detection can be achieved using any conventional object detecting method and also achieved by referring to a depth variation pattern or depth variation range using a depth of the stereo image. Here, the depth indicates a distance from the camera to the object. For example, if a depth variation pattern indicates a prominence and depression pattern such as a shoulder-head-shoulder pattern, an object having the depth variation pattern can be detected as a person. The segmentation is achieved for a head and shoulders in the image, and the segmented part hardly show a variation in the top-down view even if a person moves.

The initializing unit 12 determines whether the detected object is a new object with reference to the database 13 in operation 22.

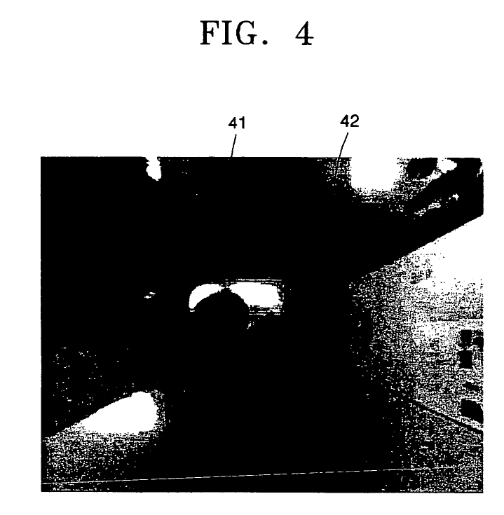

If the detected object is a new object, an ID and related information of the new object is stored in the database 13 in operation 23, and the initializing unit 12 initializes the information related to the object in operation 24. Here, the information related to the object includes depth information y₀^{depth} and color information y₀^{color} of the segmented part, i.e., a segment. The depth information, i.e., one dimensional depth map, is an average value of depths measured along a straight line 42 of any one direction from a segment 41 as shown in FIG. 4. The color information is from a color histogram included in the segment 41.

The initializing unit 12 determines whether the depth and color information of the detected object are substantially the same as values stored in the database 13, and if they are not substantially the same, the initializing unit 12 determines the detected object as a new object. The segment 41 is normalized by squaring an average of a width and height of a rectangle. Therefore, when an object is segmented from an image, it can be considered that the object is neither changed to a rotation change nor sensitive to a scale of the segment. That is, the initializing unit 12 reasonably operates even if the segment is asymmetric.

For tracking, a central position (x₀, y₀) and scale of the segment 41 in the initializing state are represented as the following equation: x₀={x₀,y₀,1.0}. Here, x₀ and y₀ indicate x and y positions of the center of the segment 41, and a value of the scale based on a width and length of the initial segment is designated as 1.0. Hereinafter, a position and scale is represented as a position.

The predicting unit 15 predicts a position of the object by obtaining prior probabilities of positions of particles in a current frame from measured values of a preceding frame. The predicting unit 15 is initialized by the initializing unit 12. The predicting unit 15 generates particles by sampling N positions in circumference of the initial position x₀ with respect to a reference segment and defines a probability for an object to exist in x₀ as p(x₀)p₀. Here, p₀ is equal to 1/N. The circumference of the initial position, which is a zone defined in a predetermined range centered around the initial position, is a search ellipse described later in the present embodiment.

Calculations of the prior probabilities and post-probabilities, which will be described, of particles are called a “particle propagation.” In general, the propagation is modeled according to known or learned motion dynamics of an object. However, under a noisy environment, observation of an object in a previous frame is not sufficient to predict a position of the object in a succeeding frame. Furthermore, when an object has complicated motion, such as when crossing with another object or moves fast, it is not easy to model dynamics of the complex motion. Though some research has been performed on learning a dynamics modeling using various examples, it is not easy for a device such as a computer to learn all possible situations, and this process is also time-consuming. Therefore, in an aspect of the present invention, a one dimensional deterministic search having a semi rotation/scale-invariant feature is performed.

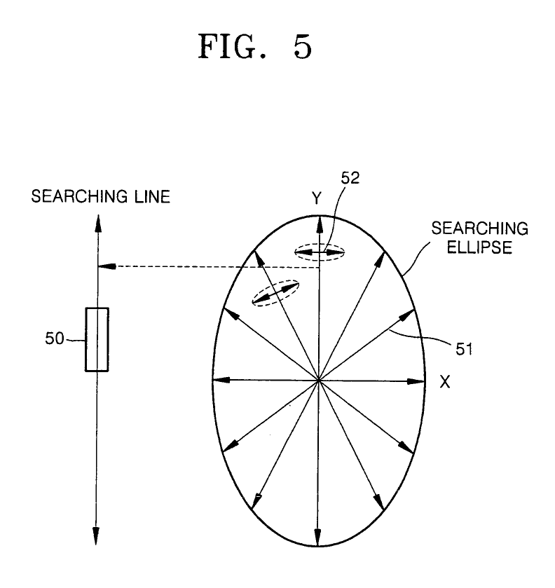

For the deterministic search, the predicting unit 15 determines a search ellipse centered around an object position xₖ₋₁ estimated from a (k-1)th frame as shown in FIG. 5 and designates twelve directional positions in the determined ellipse in operation 25. The predicting unit 15 obtains prior probabilities of twelve directional search lines 51 in operation 26. The size of the search ellipse can be determined by camera geometry according to a height of the cameras.

In the deterministic search according to an embodiment of the present invention, a depth probability using a one dimensional depth map is used as the prior probability. The depth probability can be represented as shown in Equation 1.
p(xₖ|Dₖ₋₁)≈∫p(xₖ|xₖ₋₁)p(xₖ₋₁|Dₖ₋₁,\tilde{D}ₖ)^{d}xₖ₋₁ (1)

Here, p(xₖ|Dₖ₋₁) indicates a depth probability representing a position of an object in a kth frame, which is predicted from depth information of the object measured in a (k-1)th frame, p(xₖ|xₖ₋₁) indicates a position change probability according to a frame change, and p(xₖ₋₁|Dₖ₋₁) indicates a probability of measuring depth information Dₖ₋₁ in a position xₖ₋₁ of the object in the (k-1)th frame. \tilde{D}ₖ indicates partially obtained depth information of the object in the current frame.

Also, p(xₖ₋₁|Dₖ₋₁, \tilde{D}ₖ) can be calculated using an average to correlations between y₀^{depth}, which is the depth information according to a reference depth map and a one dimensional depth map of circumferences of xₖ₋₁ in the kth frame as shown in Equation 2.

Here, the reference depth map indicates a one dimensional depth of a reference segment, and the reference segment indicates a segment of which the object appears on a picture for the first time.
p(xₖ₋₁|Dₖ₋₁,\tilde{D}ₖ)=(yₖ^{depth})^{T}y₀^{depth} (2)
Here, T indicates a transposition.

The predicting unit 15 selects positions, depth probabilities of which are larger than a predetermined value in Equation 1, or a predetermined number of positions selected in the order of largest depth probability to lowest depth probability as search candidates. For example, positions represented with a reference number 52 of FIG. 5 are selected as the search candidates. The one dimensional deterministic search is performed along the searching line in order to track a position of the object 50 in the kth frame.

The tracking unit 16 determines the number of particles with respect to the selected search candidates and generates the determined number of particles in operation 27. The number of particles can be calculated from each depth probability. That is, the maximum number of particles is obtained by multiplying the depth probability by a ratio r obtained as shown in Equation 3.

$$r = \frac{\int {( {x}_{k - 1} - {\overline{x}}_{k - 1} )}^{T} p ( {x}_{k - 1} \vert {D}_{k - 1} , {\tilde{D}}_{k} ) ( {x}_{k - 1} - {\overline{x}}_{k - 1} ) ⅆ {x}_{k - 1}}{\int {( {x}_{k - 1} - {\overline{x}}_{k - 1} )}^{T} ( {x}_{k - 1} - {\overline{x}}_{k - 1} ) ⅆ {x}_{k - 1}} \qquad ( 3 )$$

Here, \overline{x}ₖ₋₁ indicates a center position of the search ellipse of the object in the (k-1)th frame.

Physically, r is determined by a ratio of position variance of the particles in a depth distribution, in which a depth probability is reflected, to position variance of the particles in a uniform distribution. That is, since the particles are more localized through the one dimensional search, the required number of particles will be smaller than that of the uniform distribution.

The visual cue measuring unit 14 measures a visual cue of a segment in order to estimate a position of the object according to the prediction in operation 28. Here, the visual cue includes average depth, color, motion, or shape information of an object, and more exactly, represents a probability of having each information with respect to xₖ, which is a position of the object in the kth frame. The probability represents a value normalized by the scale, which each segment has.

An average depth probability p(y_{k,depth}|xₖ) is calculated by averaging differences between depths measured in a kth frame and reference depths in an initial segment. A motion probability p(y_{k,motion}|xₖ) is calculated by averaging distances between pixels observed with respect to a pixel variance of an image and reference pixels of a background image. A color histogram can be applied to a color probability p(y_{k,color}|xₖ). A shape probability p(y_{k,shape}|xₖ) is calculated by obtaining a similarity between shape information of an object obtained by performing a Laplacian operation on the segment 41 and shape information of the corresponding object stored in the database 13.

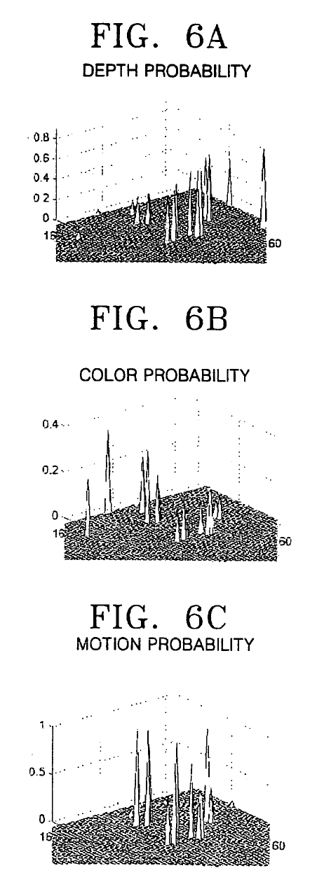

FIGS. 6A through 6C show examples of probabilities obtained from segments of an object with respect to a plurality of particles, each showing the average depth probability, color probability, and motion probability, and FIG. 6D shows a result of multiplying the probabilities of FIGS. 6A through 6C. For example, on a position of a particle corresponding to the highest value in FIG. 6D, a probability for an object to exist in the current frame can be the highest.

The tracking unit 16 calculates a post-probability p(xₖ|Dₖ) of a position and scale of the kth frame with respect to each particle using more than one or all of the average depth probability, motion probability, shape probability, and color probability output from the visual cue measuring unit 14 as shown in Equation 4 in operation 29.

$$p ( {y}_{k} \vert {x}_{k} ) = p ( {y}_{k , depth} \vert {x}_{k} ) \cdot p ( {y}_{k , color} \vert {x}_{k} ) \cdot p ( {y}_{k , motion} \vert {x}_{k} ) \cdot p ( {y}_{k , shape} \vert {x}_{k} ) \\ p ( {x}_{k} \vert {D}_{k} ) = \frac{p ( {y}_{k} \vert {x}_{k} ) p ( {x}_{k} \vert {D}_{k - 1} )}{p ( {y}_{k} \vert {D}_{k - 1} )} \qquad ( 4 )$$

Here, p(yₖ|Dₖ₋₁) indicates a probability of each value measured in the kth frame with respect to depth information of the (k-1)th frame, and is used for normalization of the post-probability.

If a position and scale of an object with respect to particles belonging to each search candidate is updated as shown in FIG. 4, a position and scale corresponding to the largest value among the updated probabilities become a position and scale of the object in the current frame, and the position and scale become a position and scale of a preceding frame when a succeeding frame is processed in operation 30.

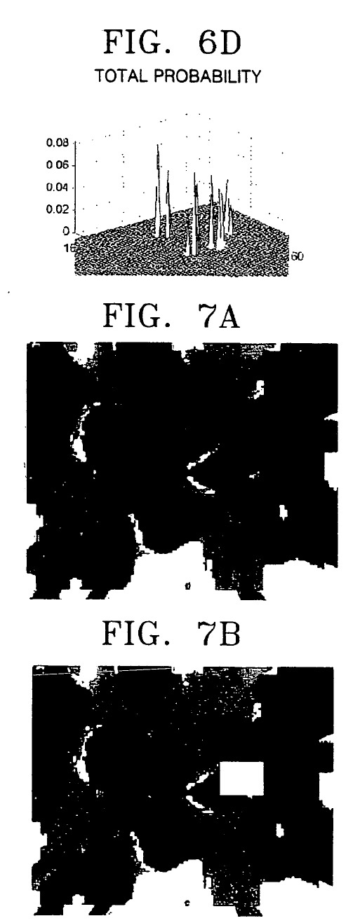

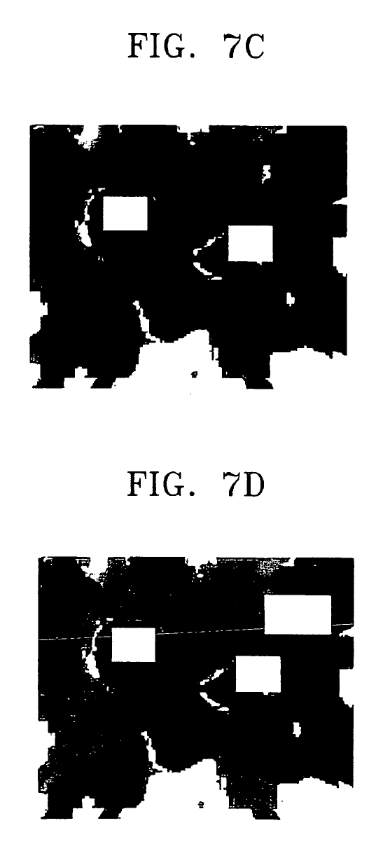

While not required in all aspects, when a position and scale of an object is updated, a masking process of the object can be further performed in operation 31. Considering that an object to be tracked is not hidden by another object since objects cannot be simultaneously located on the same position while the object is tracked through the top-down view, the object on being currently tracked is masked. Therefore, a zone occupied by another object is masked using a binary mask referred to as a support mask. This process will now be described in detail. First, a map having the same size as the image is set as 1. An object to be tracked and a zone estimated being occupied by the object are masked as 0. When another object is tracked, the masked zone is omitted from zones to be considered. However, to permit an estimation error while a single object is being tracked, a small overlap between objects can be permitted. FIGS. 7A through 7D show examples of a support mask overlapped in a depth image. FIG. 7A shows the depth image having a top-down view, and FIGS. 7B through 7D show results of masking first, second, and third objects to be tracked, respectively.

When the masking of the object to be currently tracked is finished, it is determined whether tracking of all objects in the current frame is finished in operation 32, and if there is any more object to be tracked, the tracking unit 16 moves to an object in another zone except the masked zones in operation 33, and the process is repeated from operation 22. If the tracking of all objects is finished in operation 32, it is determined whether there is an object moved outside the view by comparing the current frame to the preceding frame in operation 34, and if there is an object moved outside the view, the object is deleted from the database 13 in operation 35.

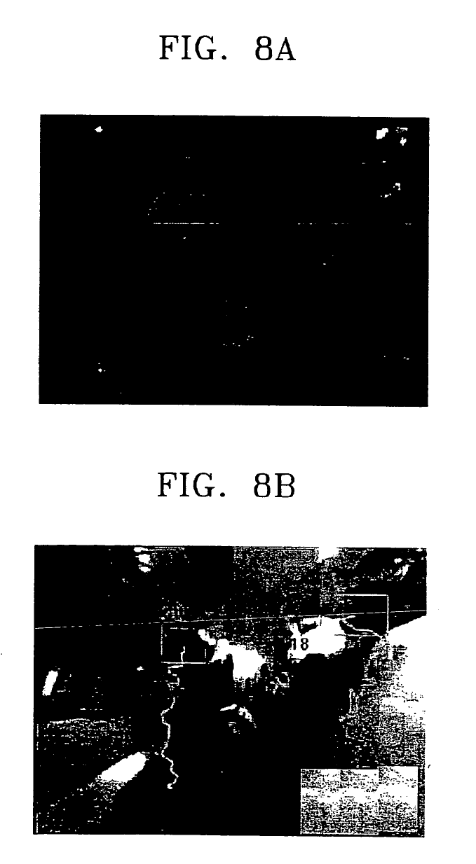

FIG. 8A shows a depth image and FIG. 8B shows a tracked trajectory of an object. Referring to FIGS. 8A and 8B, tracking of a plurality of moving objects is well performed.

Tables 1 and 2 illustrate experiment results according to an embodiment of the present invention. In the present experiments, two cameras are installed on the ceiling 2.6 m apart from the floor, each camera having a 5 m×4 m sized view. Also, the cameras output a stereo image at a speed of 5 frames per second. The experiments are performed in two cases: a simple case in which a plurality of people pass under the cameras at various speeds in various directions and a complex case in which a plurality of people pass under the cameras with complex motions such as u-turning, pausing, crossing, and accompanying products.

Table 1 shows the number of experiments of cases where a single person, 2-3 people, or more than 4 people move in a picture. Table 2 shows average tracking success rates of the cases of Table 1.

TABLE 1

| | Number of experiments | Number of experiments |
|---|---|---|
| Number of people | (simple) | (complex) |
| 1 person | 4 times | 6 times |
| 2-3 people | 4 times | 10 times |
| More than 4 people | 3 times | 4 times |

TABLE 2

| Number of people | Success rate (simple) | Success rate (complex) |
|---|---|---|
| 1 person | 100 | 83.333 |
| 2-3 people | 70.833 | 81.667 |
| More than 4 people | 95.237 | 87.728 |

Referring to Tables 1 and 2, a success rate of a total average is 85%.

Aspects of the present invention may be embodied in one or more general-purpose computers operating a program from a computer-readable medium, including but not limited to storage media such as magnetic storage media (ROMs, RAMs, floppy disks, magnetic tapes, etc.), optically readable media (CD-ROMs, DVDs, etc.), and carrier waves (transmission over the internet). The present invention may be embodied as a computer-readable medium having a computer-readable program code unit embodied therein causing a number of computer systems connected via a network to effect distributed processing. And the functional programs, codes and code segments for embodying the present invention may be easily deducted by programmers in the art which the present invention belongs to.

As described above, according to an aspect of the present invention, a relatively exact object tracking can be performed by segmenting zones of objects from an image, determining search candidate zones and a number of particles by performing a deterministic search on the basis of the segmented segments, estimating a visual cue of the search candidate zones using a stochastic searching method, and updating a position and scale of the segment based on the estimated values. Also, since support masks are used, when another object is tracked, a fast search and a relatively exact tracking can be performed by omitting masked zones.

While in an aspect of this invention it has been assumed that the input video data was variable length coded with reference to embodiments thereof, it will be understood by those skilled in the art that fixed length coding of the input video data may be embodied from the spirit and scope of the invention. Further, it is understood that the video data can be a continuous video stream and/or a discontinuous stream of images synchronized to produce corresponding stereo images.

Although a few embodiments of the present invention have been shown and described, it would be appreciated by those skilled in the art that changes may be made in this embodiment without departing from the principles and spirit of the invention, the scope of which is defined in the claims and their equivalents.

1. An object tracking method comprising:
segmenting a segment of a zone, in which an object is located, from a current frame among consecutively input images and obtaining predetermined measurement information of the segment;
determining a plurality of searching zones centered around the segment and predicting parameters of the segment in the current frame based on measurement information of a preceding frame in the plurality of the searching zones;
selecting predetermined searching zones as partial searching candidate zones from the predicted parameters of the segment in the current frame;
measuring a visual cue of the segment; and
estimating parameters of the segment of the current frame in the partial searching candidate zones based on the visual cue and the predicted parameters and determining parameters having largest estimated parameter values as parameters of the segment.

2. The method of claim 1, wherein the predetermined searching zones are zones that an ellipse having a size determined from geometry of an input inputting the images is divided into a plurality of directions centered around the segment.

3. The method of claim 1, wherein the predetermined measurement information of the segment is obtained by averaging depth information of the input images, which is measured along a straight line in any one direction in the segment.

4. The method of claim 3, wherein, when depth information of a kth frame is Dₖ and parameters of the segment are represented as xₖ, the prediction is represented as a prior probability p(xₖ|Dₖ₋₁) by the following equation:
p(xₖ|Dₖ₋₁)≈∫p(xₖ|xₖ₋₁)p(xₖ₋₁|Dₖ₋₁,\tilde{D}ₖ)dxₖ₋₁
where \tilde{D}ₖ indicates the depth information partially obtained in the current frame with respect to the object.

5. The method of claim 4, wherein p(xₖ₋₁|Dₖ₋₁, \tilde{D}ₖ) is calculated by the following equation:
p(xₖ₋₁|Dₖ₋₁,\tilde{D}ₖ)=(yₖ^{depth})^{T}y₀^{depth}
where y₀^{depth} indicates the depth information according to a one dimensional depth map of a reference segment and yₖ^{depth} indicates the depth information according to depth maps of circumference of xₖ₋₁ in the kth frame.

6. The method of claim 5, wherein, if the object is determined as a new object in the current frame, N positions are sampled in the searching zones centered around an initial position x₀ of the segment, and the prior probability of x₀ is determined as 1/N.

7. The method of claim 6, further comprising:
initializing information related to the new object by storing image information including an ID of the new object and depth and color information of the segment in a database.

8. The method of claim 7, wherein the determining of the new object comprises:
obtaining the image information; and
comparing the image information with values stored in the database, and determining the object as a new object if the image information is not substantially same with the values stored in the database.

9. The method of claim 7, wherein the initializing of the information related to the object comprises:
storing information including the ID of the new object, the image information, a central position and scale of the segment.

10. The method of claim 1, wherein the partial searching candidate zones are zones whose predicted parameter values are larger than a predetermined value, or a predetermined number of zones selected in order of a largest predicted parameter to lowest predicted parameter.

11. The method of claim 1, wherein the visual cue comprises at least one of probabilities of a color histogram, average depth information, motion information, and shape information measured with respect to the segment, or combinations thereof.

12. The method of claim 11, wherein the estimated parameters are normalized by a probability to be measured including at least one of a color histogram, average depth information, motion information, shape information in the current frame with respect to depth information measured with respect to the object in the preceding frame, or combinations thereof.

13. The method of claim 1, further comprising:
masking the segment;
searching another object by searching zones except the masked segment in the image; and
repeating from segmenting a segment of a zone through searching another object if another object exists.

14. The method of claim 13, further comprising:
searching an object, which does not appear in the current image, in the database, which stores information of the objects, and deleting the searched object from the database, if all objects in the image are masked.

15. An object tracking apparatus comprising:
an image inputting unit consecutively inputting images including a zone having an object;
an image segmenting unit detecting and segmenting a segment of the zone from a current frame among the input images and obtaining predetermined measurement information of the segment;
a predicting unit determining a plurality of searching zones centered around the segment and predicting parameters of the segment in the current frame based on the measurement information of a preceding frame in the plurality of the searching zones;
a visual cue measuring unit measuring a visual cue including at least one of probabilities of average depth information, color information, motion information, shape information of the segment, or combinations thereof; and
a tracking unit estimating parameters of the segment for the current frame in the searching zones based on the visual cue and the predicted parameters and determining parameters having largest parameters among the estimated parameters as parameters of the segment for use in tracking the object in a future frame.

16. The apparatus of claim 15, wherein the predicting unit selects zones, that an ellipse having a size determined from geometry of the image inputting unit is divided into a plurality of directions centering around the segment, as the searching zones.

17. The apparatus of claim 16, wherein the image segmenting unit obtains an average depth information measured along a straight line of any one direction in the segment, as the measurement information of the segment.

18. The apparatus of claim 17, wherein the predicting unit, when depth information of a kth frame is Dₖ and parameters of the segment are represented as xₖ, predicts the parameters according to a prior probability p(xₖ|Dₖ₋₁) using the following equation:
p(xₖ|Dₖ₋₁)≈∫p(xₖ|xₖ₋₁)p(xₖ₋₁|Dₖ₋₁,\tilde{D}ₖ)dxₖ₋₁
where \tilde{D}ₖ indicates depth information partially obtained in the current frame with respect to the object.

19. The apparatus of claim 18, wherein the predicting unit obtains p(xₖ₋₁, Dₖ₋₁, \tilde{D}ₖ) using the following equation:
p(xₖ₋₁|Dₖ₋₁,\tilde{D}ₖ)=(yₖ^{depth})^{T}y₀^{depth}
where y₀^{depth} indicates depth information according to a one dimensional depth map of a reference segment and yₖ^{depth} indicates depth information according to depth maps of circumference of xₖ₋₁ in the kth frame.

20. The apparatus of claim 15, further comprising:
a database; and
an initializing unit storing depth and color information of the segment with an ID of the new object in the database and initializing parameters of the segment, if the object is a new object.

21. The apparatus of claim 20, wherein the tracking unit further comprises:
a mask, masking the segment to classify the segment from other zones of the image, when the parameters of the segment are determined.

22. An object tracking method comprising:
detecting an object from an input image;
determining a position of the detected object;
calculating possible prior positions of the detected object;
measuring a visual cue of the detected object in order to estimate a post position of the detected object; and
calculating the post position of the detected object from the visual cue.

23. The method of claim 22, wherein the object is detected using a depth variation pattern and/or a depth variation range using the input image.

24. The method of claim 22, wherein the detected object is determined to be a new detected object based on reference information stored in a database storing previously detected objects.

25. The method of claim 24, wherein if the detected object is determined to be a new object, storing an ID and related information of the new object in the database.

26. The method of claim 25, wherein if the detected object is not the new object, the detected object is not again included in the database.

27. The method of claim 22, wherein the position of the detected object is determined by a search ellipse centered around the object.

28. A computer readable medium embedded with processing instructions for performing the method of claim 22 using a computer.

29. The method of claim 22, further comprising determining whether the detected object is a new object through review of a database of previously detected objects.

30. A computer readable medium embedded with processing instructions for performing the method of claim 1 using a computer.

31. An object tracking apparatus to track objects in images having corresponding frames, the apparatus comprising:
an image segmenting unit detecting an object in a corresponding zone of an image and segmenting a segment of the zone from a current frame and obtaining predetermined measurement information of the segment;
a predicting unit determining at least one search zone centered around the segment and predicting parameters of the segment in the current frame based on the measurement information of a preceding frame in the at least one searching zone;
a visual cue measuring unit measuring a visual cue using the segment; and
a tracking unit estimating parameters of the segment for the current frame in the search zone based on the visual cue and the predicted parameters and determining parameters having largest parameters among the estimated parameters as parameters of the segment for use in tracking the object in a future frame.
